(19) United States
(12) Patent Application Publication
(10) Pub. No.: US 2004/0068093 A1
(43) Pub. Date: Apr. 8, 2004

(54) Polymerized hydrogel comprising low amounts of residual monomers and by-products

(75) Inventors: Steven Ray Merrigan, West Chester, OH (US); Lee Arnold Schechtman, Fairfield, OH (US); Stephen Allen Goldman, Citta Sant' Angelo (IT); Martin Beck, Maxdorf (DE); Felix Christian Gorth, Ludwigshafen (DE); Christian H. Weidl, Mannheim (DE); Volker Frenz, Kostheim (DE); Oskar Stephan, Hockenheim (DE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/606,355

(22) Filed: Jun. 25, 2003

Related U.S. Application Data
(60) Provisional application No. 60/393,283, filed on Jul. 1, 2002.

(51) Int. Cl. C08G 2/00

(52) U.S. Cl. 528/490

(57) ABSTRACT

The present invention relates to a process for making polymerized hydrogel, in particular adhesives, which are characterized by very low amount of residual starting monomer(s), impurity(s) and/or by-products which could be formed during polymerization, such as acrylamide, acrylonitrile or acrolein.

After a first polymerization step, which is conducted from a reaction medium comprising starting monomer(s) and at least one polyol, the resulting hydrogel is then post-treated with a compound which chemically reacts with said residual monomer(s), impurity(s) and/or with said by-products the said polymerization could produce, to thereby reduce said residual starting monomer(s), impurity(s) and/or said by-products within said hydrogel.

The present invention also relates to polymerized hydrogels, in particular adhesives, comprising 10-90 wt % water, 10-60 wt % cross-linked hydrophilic polymer made from starting monomer(s) comprising acrylic acid, and 10-80 wt % of at least one polyol, such hydrogel being prepared by polymerizing said starting monomer(s) in the presence of said water and said polyol(s), wherein such hydrogels contain less than 500 ppb, preferably less than 100 ppb, more preferably less than 50 ppb and most preferably less than 20 ppb of α,β-unsaturated carbonyl by-product(s) derived from said polyol(s) during polymerization, and wherein the level of residual starting monomer(s) is below 200 ppm, preferably below 100 ppm, more preferably below 50 ppm, even more preferably below 20 ppm, and most preferably below 10 ppm.

### FIELD OF THE INVENTION

The present invention relates to polymerized hydrogels and processes to make such hydrogels, in particular hydrogel adhesives which are capable of attaching to mammalian skin and can be used in various personal care products, such as waste-management articles, and a variety of functional articles to be worn by a human. The hydrogels described herein are characterized by very low amount of residual starting monomers, impurities, and/or by-products that could be formed during polymerization.

### BACKGROUND OF THE INVENTION

While hydrogel, in particular body adhesives for use in consumer products such as absorbent articles and waste-management articles have previously been described in respectively, EP 1 025 823 and EP 1 025 866, the disclosure of hydrogel adhesive has mainly occurred in the context of small volume medical applications, such as skin electrodes, transdermal drug delivery and wound healing. In EP 1 025 823 and EP 1 025 866, certain hydrogel requirements for consumer products produced on a large scale, such as absorbent and human waste-management products, are disclosed, including the need for secure attachment, painless removal and stability of adhesion in presence of excess moisture.

In addition to delivering the above-mentioned benefits, it is particularly important, especially for large scale production of consumer products, that the hydrogel used must provide a very good safety profile.

In preparing low molecular-weight water-soluble and high-molecular weight polymers and copolymers that are soluble or swell up in water (partly crosslinked) it has been discovered that complete conversion of the monomers, especially monomers based on acrylic acid, was impossible. Residual contents of at least 0.5 and even 1.0% or more of free monomers are often found in polymers manufactured on an industrial scale.

Since it has been impossible up to now to carry out polymerization in such a way as to leave no residual monomers, attempts have been made to remove the residue. This can be achieved either by directly eliminating the residual monomers or by converting them into safe derivatives.

U.S. Pat. No. 4,132,844 teaches a method for directly reducing the amount of free monomers in an aqueous polymer gel by heating said polymer at a high temperature. In Japanese Patents Nos. 53/51289 and 50/136382, residual monomer content has been reduced by extraction with methanol or with methanol and water.

U.S. Pat. Nos. 2,960,486, 3,755,280, and 4,929,717 describe the treatment of a polymer gel based on acrylic acid and/or acrylamide which was made in a conventional manner, with suitable compounds. The treated polymer gel is then subsequently and systematically dried at an elevated temperature before any residual monomer content analysis.

It is known that not only the level of starting unreacted monomers, but also the level of impurities and by-products that could arise from the polymerization step such as acrolein, acrylonitrile or acrylamide, must be controlled and kept within specifically defined target levels in the eventually resulting hydrogel composition.

None of the above-cited cases were concerned in reducing impurities and/or by-products that could be produced during polymerization step of starting monomers.

It is an object of the present invention to provide a process for making polymerized hydrogels with very low amount of residual starting monomers, impurities and/or any by-products that could be produced during the polymerization step. This polymerization being conducted from within a reaction medium comprising from 10-90 wt % water, from 10-60 wt % of starting monomers and from 10-80 wt % of a polyol.

The process described in the present invention consists in two successive steps. The first one is an optimized polymerization step that leads to low levels of free starting monomer. This step is followed by a post-treatment of formed hydrogel with a compound that reacts with residual monomers, impurities and by-products that could be formed during polymerization step.

In a co-pending application, it has been disclosed that when glycerol, which belongs to the polyol family, is present in polymerized hydrogel made by UV initiation, the level of acrolein must be controlled in the finished composition, and be kept under well-defined target levels. Indeed, contact with acrolein is preferably avoided or should be minimized.

It has also been found that by controlling the pH of the monomer pre-mix solution of monomer(s), the level of acrolein formed during the polymerization reaction is reduced. Furthermore, it has been described that by carefully controlling the UV-radiation during the photopolymerization reaction, it is possible to reduce the formation of acrolein via photodecomposition of free-radical reactions involving glycerol.

It is one purpose of the present invention to provide a method for making polymerized hydrogel with very low level of acrolein. The process as claimed, comprises a step consisting in treating hydrogel formed directly after polymerization, to thereby reduce the concentration of acrolein. The present invention is also efficient for reducing the levels of other impurities or by-products including acrylonitrile and acrylamide.

While U.S. Pat. No. 5,606,094 describes a process for scavenging acrolein from a gaseous or liquid mixture containing acrolein with sodium bisulfite, the process described in the present invention provide a method for reducing acrolein content but this time, of a polymerized hydrogel.

### SUMMARY OF THE INVENTION

In one embodiment, the present invention relates to a process for making polymerized hydrogels, in particular hydrogel adhesives, comprising 10-90 wt % water and 10-60 wt % of a cross-linked hydrophilic polymer. The hydrophilic polymer is made by polymerizing at least one starting monomer type, and contains 5-80 wt %, preferably 10-80 wt %, most preferably 30-80 wt % of at least one polyol.

The process described in the present invention consists in two successive steps. The first one consists in polymerizing said starting monomer(s) from within a reaction medium comprising from 10-90 wt % water, from 10-60 wt % of said starting monomer(s) and from 10-80 wt % of at least one polyol, to thereby form a hydrogel. The level of residual starting monomers after the said polymerization step, is preferably below 10000 ppm, preferably below 1000 ppm, more preferably below 500 ppm, even more preferably below 200 ppm, even more preferably below 100 ppm, even more preferably below 50 ppm, even more preferably below 20 ppm, and most preferably below 10 ppm.

The second step consists in chemically treating the hydrogel formed in the first step, with a compound which reacts with residual monomer(s), impurity(s) and/or with any by-products produced by said polymerization reaction, to thereby reduce the concentration of said residual starting monomer(s), impurity(s) and/or said by-product(s) within said hydrogel.

In a preferred embodiment, the present invention relates to a process allowing to obtaining polymerized hydrogel, in particular adhesive, wherein the polymerization is carried at least partly by UV irradiation.

The pH of the hydrogel ranges from pH 3.5 to 7, preferably 4 to 6.5, more preferably 4.5 to 6.

In another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels contain less than 100 ppb, preferably less than 50 ppb, and most preferably less than 20 ppb of α,β-unsaturated carbonyl by-product(s) derived from said polyol(s) during polymerization, and wherein the level of residual starting monomer(s) is below 200 ppm, preferably below 100 ppm, more preferably below 50 ppm, even more preferably below 20 ppm, and most preferably below 10 ppm.

In still another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels comprise more than 20 ppb, preferably more than 50 ppb, more preferably more than 100 ppb, even more preferably more than 500 ppb, and most preferably more than 1000 ppb of nucleophilic addition product(s) of the α, β-unsaturated carbonyl by-product(s) derived from said polyol(s) during polymerization.

### DETAILED DESCRIPTION

The present invention relates to polymerized hydrogels and processes to make such hydrogels, in particular hydrogel adhesives, which are capable of attaching to mammalian skin.

In a first embodiment, the present invention relates to a process for making a hydrogel comprising 10-90 wt % water, 10-60 wt % of cross-linked hydrophilic polymer made from at least one starting monomer type, and 10-80 wt % of at least one polyol. This process comprises a first step consisting in polymerizing said starting monomer(s) from within a reaction medium comprising from 10-90 wt % water, from 10-60 wt % of said starting monomer(s) and from 5-80 wt %, preferably 10-80 wt %, most preferably 30-80 wt % of said polyol(s), to thereby form a hydrogel.

In preparing hydrogels in accordance with the present invention, the ingredients will usually be mixed to provide a reaction mixture in the form of an initial pre-gel aqueous based liquid formulation, and this is then converted into a gel by a free radical polymerization reaction. This may be achieved for example using conventional thermal initiators, redox initiators and/or photoinitiators or by ionizing radiation. Such free-radical polymerization initiators are well known in the art and can be present in quantities up to 5% by weight, preferably from 0.02% to 2%, more preferably from 0.02% to 0.4%. Photoinitiation is a preferred method and will usually be applied by subjecting the pre-gel reaction mixture containing an appropriate photoinitiation agent to UV light after it has been spread or coated as a layer on silicone-coated release paper or other solid or porous substrate.

For use in forming the homopolymer or co-polymer component of the polymerized hydrogel, suitable monomers or co-monomers can be acidic, neutral, basic, or zwitterionic. Among acidic monomers, suitable strong-acid types include those selected from the group of olefinically unsaturated aliphatic or aromatic sulfonic acids such as 3-sulfopropyl (meth) acrylate, 2-sulfoethyl (meth) acrylate, vinylsulfonic acid, styrene sulfonic acid, allyl sulfonic acid, vinyl toluene sulfonic acid, methacrylic sulfonic acid and the like and the respective salts. Particularly preferred strong-acid type monomer is 2-acrylamido-2-methylpropanesulfonic acid and its salts. Among acidic monomers, suitable weak-acid types include those selected from the group of olefinically unsaturated carboxylic acids and carboxylic acid anhydrides such as acrylic acid, methacrylic acid, maleic acid, itaconic acid, crotonic acid, ethacrylic acid, citroconic acid, fumaric acid and the like and the respective salts. Particularly preferred weak-acid type monomer is acrylic acid and its salts.

Examples of neutral monomers include N,N-dimethylacrylamide, acrylamide, N-isopropyl acrylamide, hydroxyethyl (meth)acrylate, alkyl (meth)acrylates, N-vinyl pyrrolidone and the like. Examples of cationic monomers include N,N-dimethylaminoethyl (meth)acrylate, N,N-dimethylaminoethyl (meth)acrylamide and the respective quaternary salts and the like. Most preferably, the hydrogel compositions of the invention are based upon acrylic acid monomer and its salts.

The cross-linking between polymer chains creates a 3-dimensional matrix for the polymer, also referred to as gel form or hydrogel. Physical cross-linking refers to polymers having crosslinks that are not chemical covalent bonds but are of a physical nature such that for example there are areas in the 3 dimensional matrix having high crystallinity or areas having a high glass transition temperature or areas having hydrophobic interactions. Chemical cross linking refers to polymers which are linked by covalent chemical bonds, The polymer can be chemically cross linked by radiation techniques such as V, E beam, gamma or micro-wave radiation or by co-polymerizing the monomers with a di/polyfunctional crosslinker via the use e.g., of UV, thermal and/or redox polymerization initiators. The polymer can also be ionically crosslinked.

Suitable polyfunctional monomer crosslinkers include polyethyleneoxide di(meth)acrylates with varying PEG molecular weights, IRR280 (a PEG diacrylate available from UCB Chemical), trimethylolpropane ethyoxylate tri(methacrylate with varying ethyleneoxide molecular weights, IRR210 (an alkoxylated triacrylate available from UCB Chemicals), trimethylolpropane tri(meth)acrylate, divinylbenzene, pentaerythritol triallyl ether, triallylamine, N,N-methylene-bis-acrylamide and others polyfunctional monomer crosslinkers known to the art. Preferred monomer crosslinkers include the polyfunctional diacrylates and triacrylates.

Chemical crosslinking can also be effected after polymerization by use of polyfunctional reagents capable of reacting with polymer functional groups such as ethyleneglycol diglycidyl ether, polyols such as glycerol, and other polyfunctional reagents known to the art.

Crosslinking can also be effected all or in part by ionic crosslinking wherein groups of opposite charge interact via ionic interactions. Suitable ionic crosslinking agents include those known to the art including polyvalent cations such as Al³⁺ and Ca²⁺, di/poly-amines, di/poly-quaternary ammonium compounds, including polymeric polyamines and quaternary ammonium compounds known to the art.

The hydrogel compositions described herein can comprise a humectant, or mixture of humectants (also referred as a plastisizer), which is preferably a liquid at room temperature. The humectant is selected such that the monomer and polymer may be solubilized or dispersed within. For embodiments wherein irradiation crosslinking is to be carried out, the humectant is desirably irradiation crosslinking compatible such that it does not significantly inhibit the irradiation crosslinking process of the polymer. The components of the humectant mixture are preferably hydrophilic and miscible with water.

Suitable humectants include alcohols, polyhydric alcohols such as glycerol and sorbitol, and glycols and ether glycols such as mono- or diethers of polyalkylene glycol, mono- or diester polyalkylene glycols, polyethylene glycols, glycolates, glycerol, sorbitan esters, esters of citric and tartaric acid, imidazoline derived amphoteric surfactants. Particularly preferred are polyhydric alcohols such as glycerol and sorbitol, polyethylene glycol, and mixtures thereof. Glycerol is especially preferred. The humectant comprises 5-80 wt % of the hydrogel.

Other common additives known in the art such as polymerization inhibitors, chain transfer agents, salts, surfactants, soluble or dispersible polymers, buffers, preservatives, antioxidants, pigments, mineral fillers, and the like and mixtures thereof may also be comprised within the adhesive composition in quantities up to 10% by weight each respectively.

The term polyols refer to alcohol compounds having more than one hydroxyl group. Polyols include polyhydric alcohols and are also called polyalcohols. As it was mentioned previously, polyols are well known in the art as common additives for making hydrogels. Therefore, a method for reducing by-products formed from these polyols during polymerization, is particularly useful.

In a preferred embodiment of the present invention, is provided a process where the said first step is conducted at least partly by photoinitiation polymerization. Photoinitiation will usually be applied by subjecting the pre-gel reaction mixture of monomer(s) containing an appropriate photoinitiation agent to UV light after it has been spread, coated, or extruded as a layer on silicone-coated release paper or other solid or porous substrate. The incident UV intensity, typically at a wavelength in the range from about 240 to about 400 nm overlaps to at least some degree with the UV absorption band of the photoinitiator and is of sufficient intensity and exposure duration (e.g., 120-36000 mW/cm²) to complete the polymerization of the reaction mixture.

Such free radical photoinitiation agents or photoinitiators are well known in the art and can be present in quantities up to 5% by weight, preferably less than 1%, more preferably less than 0.5%, and most preferably less than 0.4%. Such photoinitiators include type α-hydroxy-ketones and benzilidimethyl-ketals. Suitable photoinitiators include dimethylbenzylphenone (available under the trade name or Irgacure 651 from Ciba Speciality Chemicals). 2-hydroxy-2-methyl-propiophenone (available under the trade name Darocur 1173 from Ciba Speciality Chemicals), 1-hydroxycyclohexyl-phenyl ketone (available under the trade name Irgacure 184 from Ciba Speciality Chemicals), diethoxyacetophenone, and 4-(2-hydroxyethoxy)phenyl-(2-hydroxy-2-methylpropyl) ketone (available under the trade name of Irgacure 2959 from Ciba Speciality Chemicals). Darocure 1173, Irgacure 2959 and Irgacure 184 are preferred photoinitiators. Irgacure 2959 and Irgacure 184 are particularly preferred. In the hydrogel compositions described in the present invention, Irgacure 2959 is the most preferred photoinitiator. Combinations of photoinitiators can also be used. In addition, polymerization can be carried out by using thermal initiator(s) and/or redox initiator(s) well known to the art or one or more of these initiators in combination with the aforementioned photoinitiators. Suitable thermal initiators include potassium persulfate and VA044 (available from Wako). Suitable redox initiators include the combination of hydrogen peroxide and ascorbic acid and sodium persulfate and ascorbic acid.

It has been shown that during the photopolymerization process, when glycerol is used as the polyol, it can produce acrolein as a by-product. A method suitable for measuring the level of acrolein in a polymerized adhesive hydrogel is described in the Test Methods section.

Without being bound by theory, it is believed that acrolein (2-propenal) can be formed by acid-catalyzed or base-catalyzed reactions of glycerol and glycerol esters with free radicals generated during photopolymerization, wherein the concentration of free radicals are especially high. It is believed that by controlling the pH within the limits described hereinafter, the amount of acrolein generated during photo-polymerization as a result of these acid or base catalyzed reactions can be diminished.

Also, without being bound by theory, it is believed that the analogous reaction(s) can occur with other polyols yielding α,β-unsaturated carbonyl by-products such as ene-als, ene-ones and the like.

It has been described, in a co-pendant application, that by controlling the pH of the monomer pre-mix solution in the range of 3.5 to 7, preferably 4-6.5, more preferably 4.5-6; that the level of acrolein formed during the polymerization reaction is reduced. This is especially important to control the level of acrolein in the finished hydrogel.

Furthermore, it has been found that the wavelength of the UV-radiation should be carefully controlled during the photopolymerization reaction, to obtain optimum results on reduction of acrolein. It is preferable to minimize the relative percentage of UV irradiation reaching the monomer solution and hydrogel with wavelengths below 280 nm, preferably below 300 nm, more preferably below 320 m, most preferably below 335 nm. This can be achieved by the use of a UV light source that has inherently low output in these wavelength ranges or by interposing one or more high-pass UV-filters between the UV light source and the monomer solution and hydrogel.

Examples of high-pass UV filters that can be used for this purpose include the Borofloat UV Filters (e.g., T320) available form Bedamfpurgs-technik. Other examples include the high-pass UV filters made by Schott GlassWerks (e.g, WG-280, WG-295, WG-305, WG-320, and WG-325). It is preferred that the integrated UV intensity in units of W/cm2 in the aforementioned wavelength regions by reduced to less than 10%, preferably less than 7%, more preferably less than 4%, most preferably less than 1% of the integrated UV intensity in the entire region (i.e., 200-400 nm).

Without being bound by theory, it is also believed that reducing the UV irradiation in the aforementioned wavelength ranges also reduces the formation of acrolein via photodecomposition or fee-radical reactions involving glycerol.

Nevertheless, the preferred overall strategy is to choose polymerization conditions that reduce the concentration of starting monomers and their impurities to very-low levels, even if it generates an increased concentration of by-products.

In the case where the polymerization is conducted at least partly by UV irradiation, this step may depend on two process parameters, the incident UV peak intensity (in units of W/cm²) and/or the total UV energy (in units of J/cm²). It is preferred to use UV irradiation, which leads to a total UVA energy ranging from 0.1-30 J/cm², preferably from 0.1-25 J/cm², more preferably from 1-20 J/cm². These conditions are those preferred at driving down the starting monomer(s).

The resulting hydrogel of step 1) contains less than 10000 ppm, preferably less than 5000 ppm, more preferably less than 1000 ppm, even more preferably less than 500 ppm, even more preferably less than 200 ppm, even more preferably less than 100 ppm, even more preferably less than 50 ppm, even more preferably less than 20 ppm, and most preferably less than 10 ppm of residual starting monomer(s). Additionally, it is preferred that the resulting hydrogel comprise from 10-90 wt %, preferably from 20-70 wt % water.

The process as claimed in the present invention comprises a chemical treatment, preferably a post-polymerization chemical treatment, of the hydrogel, with a compound that reacts with residual monomers, impurities and/or by-products of the polymerization reaction.

Residual monomers are the unreacted monomers of the hydrophilic crosslinked polymer of the current invention.

Impurities include conjugated olefins such as acrylonitrile, acrylamide, acrolein, acrylates, t-butylacrylamide, other substituted acrylamides and the like that are introduced into the hydrogel premix in minor amounts along with the main ingredients. Some conjugated olefins can be found as impurities and also be formed as by-products of the polymerization reaction.

The chemical treatment refers to any chemical reactions known in the art that may be applied to a compound. These reactions include, but are not limited to, substitution, addition, elimination, cyclisation, pericyclic reaction, oxidation, and reduction. Addition reactions are particularly preferred in the process described in the present invention.

The by-products of the polymerization reaction refer to all products that are produced from any ingredients of the reaction medium including impurities, whatever the polymerization conditions applied are. The by-products produced from said polyol(s) are of particular concern in the present invention.

These by-products may comprise α,β-unsaturated carbonyls such as acrolein, acrylamides, acrylates, and the like. For example, as it was previously mentioned glycerol can produce acrolein as a decomposition product during the photopolymerization step. It is also known that acrylamido-2-methane propanesulfonic acid (AMPS) can decompose to generate acrylamide. Acrolein is the by-product of particular concern in the present invention. But other by-products that could derive from common additives used for making hydrogels, are within the scope of the invention.

The compound that reacts with residual monomers, impurities, and/or by-products can be in particular, a nucleophile, an oxidizing agent, a reducing agent, or a conjugated diene. For the process described in the present invention, it is particularly preferred that the compound be a nucleophile.

Suitable nucleophiles include the whole range of hetero nucleophiles wherein hetero nucleophiles are nucleophiles with a polarizable heteroatom like N, S, O or P. Preferred nucleophiles are ammonia, ammonium salts of mineral and carboxylic acids (e.g. chlorides, bromides, sulfates, phosphates, formiates, acetates, acrylates, propionates, tartrates and the like), arylamines (wherein aryl preferably means monocyclic or bicyclic aromatic rings which are optionally substituted by one, two or more substituents. The substituents are independently of each other preferably selected from the group consisting of C1-C6-alkyl, OH, C1-C6-alkoxy, nitro, halogen etc. Examples are e.g. aniline, methylaniline, benzylaniline, xylidine and the like), heteroaromates (wherein heteroaromates preferably means monocyclic or bicyclic aromatic rings with one, two, or more heteroatoms like N, O, S, which are optionally substituted by one, two or more substituents. The substituents are independently of each other preferably selected from the group consisting of C1-C6-alkyl, OH, C1-C6-alkoxy, nitro, halogen etc. Preferred are N-heteroaromates. Examples are e.g. pyridine, imidazole, methylimidazole etc.), alkylamines and/or their mineral or carboxylic salts (alkylamines means preferably mono-, di- or trialkylamines with C1-C6 alkyl chains wherein two alkyl chains can form together with the N a ring of 5 or 6 members. Examples are e.g., piperidine, piperizine, mono-, di- and tri-butylamine, dimethylamine, diethylamine, dipropaneamine, triethylamine, etc.), multifunctional amines (which are preferably mono-, di- or triamines of alkyl or aryl amines. Examples are e.g. hexamethylenediamine, ethylenediamine, propanediamine diethylenetriamine) polyamines (e.g. polyvinylamine), hydroxylamine, hydrazine, aminoguanidine, alkali sulfites, ammonium sulfites, alkali or ammonium hydrogen sulfites, alkali-, or ammonia-metabisulfites or -bisulfites, hydrogen halide, bromosuccinimide, pyridinium bromide, bromine, or thiols. Aminoguanidine, bisulfite and metabisulfite are particularly preferred in the present invention.

Oxidizing agents may include permanganate, bichromate, chromate, selenium dioxide, osmium tetroxide, sodium periodate, ozone, peroxides (sodium persulfate, dibenzoylperoxide etc.) or hydroperoxides (e.g. benzoylhydroperoxide, hydrogeneperoxide).

Reducing agents may include metal hydrides, sodium hypochlorite, metals and their salts of mineral and carboxylic acids (e.g. chlorides, bromides, sulfates, phosphates, formiates, acetates, acrylates, propionates, tartrates and the like), Grignard reagents, alkali and ammonia sulfites, methane sulfine acids and their salts, e.g. sodium formaldehyde sulfoxylate, saccharides (e.g. ascorbic acid, glucose, frutose and the like).

Dienes may include cyclopentadiene, hexachlorocyclopentadiene, isoprene, 2-methoxybutadiene, and the like.

When the compound is a nucleophile, it is particularly preferred that it react with the double bond(s) of the starting monomers, impurities and/or the by-products by an addition reaction.

In the process of the present invention, the compound which reacts with said residual starting monomer(s), impurity(s) and/or by-products is preferably present in amounts of less than 30000 ppm, preferably less than 10000 ppm, more preferably less than 5000 ppm, most preferably less than 3000 ppm, with respect to the hydrogel.

In the process of the present invention, the compound which reacts with said aforementioned starting monomers, impurities, and/or by-products is preferably applied uniformly to the surface of the hydrogel via spraying, slot coating, printing, transfer, and the like processes in solution. Preferably the solution is aqueous and also preferably the quantity of added solution is sufficiently low relative to the area of the hydrogel such that it can be rapidly absorbed (e.g., preferably less than 0.01 g/cm2, more preferably less than 0005 g/cm2, even more preferably less than 0.001 g/cm2).

The resulting hydrogel contains less than 200 ppm, preferably less than 100 ppm, more preferably less than 50 ppm, and even more preferably less than 20 ppm, most preferably less than 10 ppm of all residual monomer(s). Additionally, it is preferred that the resulting hydrogel contain less than 1000 ppb, preferably less than 500 ppb, more preferably less than 100 ppb, even more preferably less than 50 ppb, and most preferably less than 20 ppb of by-product(s) derived from said polyol(s) during polymerization. Furthermore, and if applicable, it is preferred that the polymerized hydrogel contain less than 100 ppb, preferably less than 50 ppb, more preferably less than 25 ppb and most preferably less than 10 ppb of acrylonitrile and/or acrylamide.

In another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels contain less than 100 ppb, preferably less than 50 ppb, and most preferably less than 20 ppb of α,β-unsaturated carbonyl by-product(s), derived from said polyol(s) during polymerization, and wherein the level of residual starting monomer(s) is below 200 ppm, preferably below 100 ppm, more preferably below 50 ppm, and even more preferably below 20 ppm, and most preferably below 10 ppm.

In yet another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels contain less than 100 ppb, preferably less than 50 ppb, and most preferably less than 20 ppb of acrolein and wherein the level of residual starting monomer(s) is below 200 ppm, preferably below 100 ppm, more preferably below 50 ppm, and even more preferably below 20 ppm, and most preferably below 10 ppm.

In still another embodiment, the present invention relates to polymerized hydrogel, in particular adhesive, comprising 10-90 wt % water, 10-60 wt % of cross-linked hydrophilic polymer made from starting monomer(s), and 10-80 wt % of at least one polyol, such hydrogel being prepared by polymerizing said starting monomer(s) in the presence of said water and polyol(s), wherein such hydrogels comprise more than 20 ppb, preferably more than 50 ppb, more preferably more than 100 ppb, even more preferably more than 500 ppb, and most preferably more than 1000 ppb of nucleophilic addition product(s) of the α,β-unsaturated carbonyl by-product(s) derived from said polyol(s) during polymerization.

The aforementioned nucleophilic addition product(s) refer to all products resulting directly or indirectly from said addition reaction between a suitable nucleophile(s) and α,β-unsaturated carbonyl by-product(s) derived from said polyol(s) during polymerization. The resulting possibilities are innumerable but when bisulfite is selected to be said suitable nucleophile, and acrolein is selected as the α,β-unsaturated carbonyl, the addition products can comprise sodium-3-propanal sulfonate, 1-hydroxy-2-propene-1-sulfonate, 1-hydroxy-1.3-propane disulfonate.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Test Methods

1. pH of Monomer Solutions

The pH of a monomer solution can be measured using methods well known to the art. For example, an Ionlabph/ion level 2P meter can be used equipped with a SenTix 41 electrode (available from Wissenschaftlich Technische Werkstaetten).

2. pH of Hydrogel

The pH of the hydrogel is measured using an electronic pH meter, for example as supplied by Mettler Toledo, and a flat bulb electrode, for example type InLab 426, calibrated as per the manufacturers instructions. The bulb is brought into contact with the surface of the gel and the measurement is recorded after some seconds, once the value on the display is constant. The electrode is rinsed with distilled water between successive measurements.

3. Residual NaAMPS in Polymerized Hydrogels

Sample Preparation: Add 100 ml of 0.9% w/v saline solution to 1.0000 g of hydrogel and put the mixture in a thermostatic bath for a minimum of 12 hours at approximately 40° C. Collect an aliquot of the supernatant through a 0.45 μm hydrophilic filter into a syringe and then transfer into a HPLC autosampler vial.

Analysis: HPLC/DAD—100 μl of the hydrogel filtrate (as above) is injected directly into the HPLC, for example a Waters Millennium 2020 C/S equipped with a Waters 600 solvent delivery module, Waters 717+auto injector, Waters 996 photo diode array detector and a Merck Chromolith RP18e 100×4.6 mm column set. The mobile phase comprises 99% of eluent A (H₃PO₄ 0.0146M) and 1% of eluent B (Acetonitrile). The flow rate is 1.8 mil/min. For detection a photo diode array channel 200 nm (bandwidth 1.2 nm) is used, the UV Spectra across 190-360 nm can be applied for peak purity assessment. The level of analyte is quantified using standard procedures well known to the art and reported as micrograms analyte per gram of hydrogel (ppm).

4. Residual Acrolein in Polymerized Hydrogels

Sample Preparation: Add 100 ml of 0.9% w/v saline solution to 1.0000 g of hydrogel in a capped glass container. The resulting mixture is placed in a thermostatic bath for a minimum of 12 hours at approximately 40° C. The liquid is separated from the gel and collected. The headspace of this solution (2000 μof vapor phase) is analyzed as described below.

Analysis: Follow procedure outlined in U.S. EPA method 8240.

Injector: ThermoFinnigan PTV (Programmed Temperature Vaporizing).

The level of analyte is quantified using standard procedures well known to the art and reported as nanograms analyte per gram of hydrogel (ppb).

5. Residual Acrylamide in Polymerized Hydrogel

Sample Preparation: Add 100 ml of 0.9% w/v saline solution to 1.0000 g of hydrogel in a capped glass container, the resulting mixture is placed in a thermostatic bath for a minimum of 12 hours at approximately 40° C. The supernatant is separated from the gel and collected. The supernatant is analyzed as outlined below.

Analysis: Follow procedure outlined in U.S. EPA method 8032A. Detection is via MS in negative CI mode with methane as the reactant gas.

The level of analyte is quantified using standard procedures well known to the art and reported as nanograms analyte per gram of hydrogel (ppb).

6. Residual Acrylic Acid in Polymerized Hydrogels

Sample Preparation: Add 100 ml of 0.9% w/v saline solution to 1.0000 g of hydrogel in a capped glass container. The resulting mixture is placed in a thermostatic bath for a minimum of 12 hours at approximately 40° C. Collect the supernatant through a 0.45 μm hydrophilic filter into a syringe and then store in an HPLC autosampler vial. The filtrate is analyzed as described below.

Analysis: Follow procedure outlined in EDANA method 410.1. The level of analyte is quantified using standard procedures well known to the art and reported as micrograms analyte per gram of hydrogel (ppm).

7. Residual Bisulfite Addition Products of Acrolein By-Product

Sample Preparation: Add 100 ml of 0.9% w/v saline solution to 1.0000 g of hydrogel in a capped glass container. The resulting mixture is placed in a thermostatic bath for a minimum of 12 hours at approximately 40° C. Collect the supernatant through a 0.45 μm hydrophilic filter into separatory funnel. Acidify to pH 2 with concentrated hydrochloric acid, followed by 3 rinses with a solution of 90:10 ethyl acetate:hexanes. Concentrate the aqueous phase by 10 times by rotary evaporation.

Analysis: Concentrated aqueous solution (5 μl) is put into a ms/ms equipped with a direct insertion probe. The level of analyte is quantified using standard procedures well known to the art and reported as nanograms analyte per gram of hydrogel (ppb).

### EXAMPLES

### Example 1

### Preparation of NaAMPS/Acrylic Acid Co-Polymer Hydrogel

Approximately 17 parts of 2-acrylamido-2-methyl-1-propanesulphonic acid (AMPS), which was recrystallized one time from methanol, is added to a solution containing approximately 0.02 parts MEHQ inhibitor (4-methoxyphenol, Aldrich), approximately 0.51 parts potassium phosphate buffer (Aldrich), and approximately 27.32 parts distilled water and allowed to dissolve. The reaction mixture is cooled with an ice-cold water bath to maintain the temperature of the reaction mixture below approximately 25° C. as approximately 6 parts of approximately 50 wt % NaOH (Aldrich) is added dropwise. The level of NaOH added is slightly less than one equivalent relative to the level of acid AMPS. After the addition of the NaOH is completed, another aliquot of approximately 17 parts Acid AMPS is dissolved in the reaction mixture before adding dropwise another approximately 6 parts of the 50 wt % NaOH. After the second addition of 50 wt % NaOH is completed another aliquot of approximately 17 parts Acid AMPS is dissolved in the reaction mixture before adding dropwise another approximately 6 parts of 50 wt % NaOH. A final addition of approximately 1.43 parts of acid AMPS is dissolved in the reaction mixture followed by the final dropwise addition of approximately 2.24 parts of 50 wt % NaOH. The final pH of the mixture is adjusted to approximately pH=5 with dropwise addition of a small quantity of NaOH. This yields an approximately 58 wt % aqueous NaAMPS solution.

To a solution of approximately 22.4 parts of the approximately 58 wt % NaAMPS solution and approximately 13.2 parts of distilled water, approximately 19.2 parts of acrylic acid is added. To this solution approximately 6.4 parts of 50 wt % NaOH (Aldrich) is added dropwise with constant stirring, while maintaining the temperature to less than approximately 25° C. with an ice bath. The NaOH that is added is sufficient to convert approximately 30 mole % of the acrylic acid to sodium acrylate. Approximately 38.9 parts of glycerol (Agar) is added and the resulting mixture is stirred for 15 min. The solution is covered to shield it from light.

To this solution approximately 0.13 parts of the polyfunctional cross-linker IRR210 and 0.23 parts of Darocur 1173 is added to approximately 100 parts of the monomer solution and dispersed and/or dissolved with stirring for approximately 15 minutes.

The monomer solution is extruted at a basis weight of approximately 1.0 kilograms per square meter onto nonwoven webbing (for example, 911NW available from Fuller), The monomer solution is polymerized via UV irradiation curing. The peak power density and the total energy density of the lamps are measured using a UV Power Puck (E.I.T. Inc.) and the output intensity and energy (in the UV-A range) of the lamps are adjusted so that the incident UVA peak power density on the sample is approximately 1.10 Watt/cm² and the UVA energy density is approximately 18.2 J/(measured with UV filter). The sample is passed, at the line speed of 3.5 meter per minute, underneath twelve consecutive lamps equipped with UV filters (for example Bte Bedampfungstechnik GmbH filters, with Transmittance (T)=50% at 320 nm, T<1% in the range 220-310 nm, T>85% in the range 330-2000 nm) to polymerize the monomer solutions and convert them into adhesive hydrogels. After polymerization a release liner (for example CS42 from Cogesil) is applied to the hydrogel and it is rolled up for storage.

### Example 2

### Post Treatment of NaAMPS/Acrylic Acid Co-Polymer Hydrogel with 10,000 μm of Nucleophiles

To a solution of approximately 47.5 parts water and 47.5 parts glycerol was added 5 parts KH₂PO₄ buffer. The resulting mixture was stirred for approximately 15 minutes.

Solutions containing 20 parts nucleophile are prepared using the following procedure. To approximately 80 parts of the phosphate buffer solution is added approximately 20 parts of nucleophile. The resultant mixture is stirred for approximately 15 minutes. The resulting solution is used for hydrogel post-treatment on the same day it is made.

Solutions containing of the following nucleophiles are prepared: piperidine, piperizine, 1,7-heptadiene, and sodium metabisulfite:

Hydrogels made according to example 1 are cut into squares weighing approximately 10 g. The weight of each of the hydrogel pieces is determined gravimetrically. The release paper is removed and each of the nucleophile solutions is sprayed approximately uniformly on the surface of the hydrogel at an add-on of approximately 5% by weight nucleophile solution relative to the hydrogel. This corresponds to the addition of approximately 10000 ppm of nucleophile to the hydrogel. The weight of solution added to the hydrogel is determined gravimetrically (the solutions are sprayed using, for example, a Gelman Chromist aerosol propellant available from Aldrich). After the nucleophile is added, the release paper is reapplied to the top surface of the hydrogel and the sample is stored in 2 ziplock bags at ambient temperature for at least 10 days to allow for diffusion of the nucleophile within the hydrogel and reaction. For reference purposes, a reference hydrogel sample is treated as described previously with phosphate buffer solution without added nucleophile. After storage, the concentration of residual monomers, impurities, and by-products in the hydrogel samples are determined using the methods described in the Test Method section and the results are given in Table 1: reference with no nucleophile (2-0), piperidine (2-1), piperizine(2-2), 1,7-heptadiene(2-3), and sodium metabisulfite (2-4).

It can be seen that addition of metabisulfite to the hydrogel at 10,000 ppm is highly effective at reducing the concentrations all of the residual monomers, impurities, and by-products that are analyzed. Piperizine is very effective at reducing the concentration of acrylic acid and effective at reducing the concentrations of acrylamide and NaAMPS. Piperidine and 1,7-heptadiene are effective at reducing the concentration of acrylic acid. While not being bound by theory, it is believed that the amine nucleophiles in this example are less effective than metabisulfite due to protonation at the acidic pH of this hydrogel.

### Example 3

### Post Treatment of NaAMPS/Acrylic Acid Hydrogel with 1000 ppm of Sodium Metabisulfite

The procedure described in Example 2 for post addition of metabisulfite is repeated except that approximately 2.0 parts of metabisulfite is added to 98 parts of the phosphate buffer solution. This corresponds to a weight add on of metabisulfite of approximately 1000 ppm. After storage, the concentration of residual monomers, impurities, and by-products in the hydrogel sample (3-1) is determined using the methods described in the Test Method section and the results are given in Table 1. It can be seen that addition of metabisulfite to the hydrogel at 1000 ppm is effective at reducing the concentrations of residual monomers, impurities, and by-products.

### Example 4

### In-Line Post Treatment of Acrylic Acid Hydrogel with Metabisulfite

A solution of approximately 6 parts sodium metabisulfite in 96 parts distilled water is stirred for approximately 15 minutes. The resulting solution is used on the same day it is made.

To a solution of approximately 32 parts of acrylic acid (BASF) is added approximately 25. parts of distilled water. To this solution approximately 3.6 parts of 50 wt % NaOH (Aldrich) is added dropwise with constant stirring, while maintaining the temperature to less than approximately 25° C. with an ice bath. The NaOH that is added is sufficient to convert approximately 10 mole % of the acrylic acid to sodium acrylate. Approximately 39.5 parts of glycerol (Agar) is added and the resulting mixture is stirred for 15 min. The solution is covered to shield it from light.

To this solution, approximately 0.177 parts of the polyfunctional cross-linker IRR210 and 0.228 parts of Darocur 1173 is added to approximately 100 parts of the monomer solution and dispersed and/or dissolved with stirring for approximately 15 minutes.

In a continuous process, the monomer solution is extruted at a basis weight of approximately 1.0 kilograms per square meter onto nonwoven webbing (for example, 911NW available from Fuller). The monomer solution is polymerized via UV irradiation curing. The peak power density and the total energy density of the lamps are measured using an UV Power Puck (E.I.T Inc.) and the output intensity and energy (in the UV-A range) of the lamps are adjusted so that the incident UVA peak power density on the sample is approximately 1,100 Watt/cm² and the UVA energy density is approximately 18.2 J/cm² (measured with the UV filter). The sample is passed, at the line speed of 3.5 meter per minute at the line speed of 3.5 meter per minute, underneath twelve consecutive lamps equipped with UV filters (for example Bte Bedampfungstechnik GmbH filters, with Transmittance (T)=50% at 320 nm, T<1% in the range 220-310 nm, T>85% in the range 330-2000 nm) to polymerize the monomer solutions and convert them into adhesive hydrogels. After polymerization, but prior to application of release liner, the sodium metabisulfite solution is uniformly applied onto the exposed upper surface of the hydrogel at a basis weight of 50 g/m² via a spray applicator (for example SUE18 from Spraying System CO). This corresponds to the addition of approximately 3000 ppm of metabisulfite. After post addition a release liner (for example CS42 from Cogesil) is applied to the hydrogel and it is rolled up for storage (4-1). A reference sample of hydrogel surface treated with a comparable quantity of distilled water is also prepared (4-0). These samples are stored under ambient conditions for at least 10 days prior to measurement of residual monomers and by-products. The results are given in Table 1. It can be seen that although the polymerizations conditions used in this example is very effective at reducing the level of residual acrylic acid monomer, a high level of acrolein is generated as a byproduct of glycerol. In-line post addition of metabisulfite is highly effective at reducing the level of acrolein generated during this polymerization reaction.

### Example 5

### In-Line Post Treatment of NaAMPS/Acrylic Acid Co-Polymer Hydrogel with Metabisulfite

To a solution of approximately 22.4 parts of an approximately 58 wt % NaAMPS solution prepared as described in Example 1 are added approximately 13.2 parts of distilled water and approximately 19.2 parts of acrylic acid. To this solution approximately 6.4 parts of 50 wt % NaOH (Aldrich) is added dropwise with constant stirring, while maintaining the temperature to less than approximately 25° C. with an ice bath. The NaOH that is added is sufficient to convert approximately 30 mole % of the acrylic acid to sodium acrylate. Approximately 38.9 parts of glycerol (Agar) is added and the resulting mixture is stirred for 15 min. The solution is covered to shield it from light.

To this solution, approximately 0.13 parts of the polyfunctional cross-linker IRR210 and 0.23 parts of Darocur 1173 is added to approximately 100 parts of the monomer solution and dispersed and/or dissolved with stirring for approximately 15 minutes.

In a continuous process, one aliquot of the monomer solution is extruded and polymerized as described in example 4 at a basis weight of approximately 1.0 kilograms per square meter onto nonwoven webbing (for example, 911NW available from Fuller). After polymerization, but prior to application of release liner, a sodium metabisulfite solution prepared as described in example 4 is uniformly applied onto the exposed upper surface of the hydrogel at a basis weight of 50 g/m² via a spray applicator (for example SUE18 from Spraying System CO). This corresponds to the addition of approximately 3000 ppm of metabisulfite (5-1-1). A reference sample of hydrogel that is surface treated with a comparable quantity of distilled water is also prepared (5-1-0). These samples are stored under ambient conditions for at least 10 days prior to measurement of residual monomers and by-products. The results are given in Table 1.

In a continuous process, a second aliquot of the monomer solution, the UV irradiation conditions are modified such that the intensity of irradiation increases in two steps from the beginning to the end of the process (positive UV ramp). The UVA peak power density is approximately 0.55 Watt/cm² (measured with the UV filter) for each of the first 4 lamps, 0.80 Watt/cm² (measured with the UV filter) for each of lamps 5-8, and 1.10 Watt/cm² (measured with the UV filter) for each of lamps 9-12. The total UVA energy density is approximately 12.3 J/cm² (measured with the UV filter).). After polymerization, but prior to application of release liner, the sodium metabisulfite solution is uniformly applied onto the exposed upper surface of the hydrogel at a basis weight of 50 g/m² as described previously This corresponds to the addition of approximately 3000 ppm of metabisulfite (5-2-1). A reference sample of hydrogel that is surface treated with a comparable quantity of distilled water is also prepared (5-2-0). These samples are stored under ambient conditions for at least 10 days prior to measurement of residual monomers and by-products. The results are given in Table 1.

It can be seen that both of the polymerizations conditions used in this example are very effective at reducing the level of residual acrylic acid and NaAMPS monomers and that in-line post addition of metabisulfite is highly effective at reducing the level of acrolein generated during these polymerization reactions. It can also be seen that the positive UV ramp results in a lower amount of acrolein.

For solution 5-2, the peak power density, the total energy density and the output intensity and energy (in the UV-A range) of the lamps are adjusted so that the incident UVA peak power on the sample is a positive ramp as described below.

The UVA peak power density profile for the positive UV ramp is approximately 0.55 Watt/cm² (measured with the UV filter) for each of the first 4 lamps, 0.80 Watt/cm² (measured with the UV filter) for each of lamps 5-8, and 1.10 Watt/cm² (measured with the UV filter) for each of lamps 9-12. The total UVA energy density is approximately 12.3 J/cm² (measured with the UV filter).

The monomer solution passed, at the line speed of 3.5 meters per minute, underneath twelve consecutive lamps equipped with UV filters (for example Bte Bedampfungstechnik GmbH filters, with Transmittance (T)=50% at 320 nm, T<1% in the range 220-310 nm, T>85% in the range 330-2000 nm) to polymerize the monomer solutions and convert them into adhesive hydrogels After polymerization, but prior to application of release liner, the sodium metabisulfite solution is uniformly applied onto the exposed upper surface of the hydrogel at a basis weight of 50 g/m² via a spray applicator (for example SUE18 from Spraying System CO). This corresponds to an add on of solution to the hydrogel of approximately 5%. This corresponds to the addition of approximately 3000 ppm of metabisulfite. After post addition a release liner (for example CS42 from Cogesil) is applied to the hydrogels and they are rolled up for storage.

Measurement of the residual monomers and impurities were completed and the results are included in table 1: option 1: Darocur 1173 reference (without sodium metabisulfite) (10-1-1-0), Darocur 1173 with 3000 ppm sodium bisulfite (10-1-1-1) Irgacure 2959 reference (without sodium metabisulfite) (10-2-1-0), : Irgacure 2959 with 3000 ppm sodium bisulfite (10-2-1-1). Option 2: Darocur 1173 reference (without sodium metabisulfite) (10-1-2-0), Darocur 1173 with 3000 ppm sodium bisulfite (10-1-2-1)

### Example 6

### In-Line Post Treatment of NaAMPS/Acrylic Acid Co-Polymer Hydrogel with Metabisulfite

A monomer solution is prepared as described in example 5 except that the Darocur 1173 is replaced with 0.40 parts of Irgacure 2959. In a continuous process, the monomer solution is extruded and polymerized as described in example 4 at a basis weight of approximately 1.0 kilograms per square meter onto nonwoven webbing (for example, 911NW available from Fuller). After polymerization, but prior to application of release liner, a sodium metabisulfite solution prepared as described in example 4 is uniformly applied onto the exposed upper surface of the hydrogel at a basis weight of 50 g/m² via a spray applicator as described in example 4. This corresponds to the addition of approximately 3000 ppm of metabisulfite (6-1). A reference sample of hydrogel that is surface treated with a comparable quantity of distilled water is also prepared (6-0). These samples are stored under ambient conditions for at least 10 days prior to measurement of residual monomers and by-products. The results are given in Table 1.

It can be seen that Irgacure 2959 is effective at reducing the concentrations of NaAMPS and acrylic acid, while forming a lower amount of acrolein than Darocur 1173 under comparable polymerization conditions. It can also be seen that in-line post addition of metabisulfite is highly effective at reducing the level of acrolein generated in hydrogels photopolymerized with Irgacure 2959.

TABLE 1
Residual Levels of Monomers and Impurities in Polymerized
Hydrogels

| Hydrogel | NaAMPS | Acrylic Acid | Acrylamide | Acrolein |
|---|---|---|---|---|
| Example # | (ppm)* | (ppm)* | (ppm)* | (ppm)* |
| (2-0) | 2045 | 1345 | 0.96 | 0.24 |
| (2-1) | 1890 | 1030 | 0.82 | 0.29 |
| (2-2) | 1750 | 88 | 0.53 | 0.31 |
| (2-3) | 2060 | 874 | 0.90 | 0.19 |
| (2-4) | <10 | <10 | <0.01 | <0.02 |
| (3-1) | 1485 | 467 | 0.74 | 0.12 |
| (4-0) | NA | 44 | NA | 3.37 |
| (4-1) | NA | 54 | NA | 0.11 |
| (5-1-0) | <10 | <10 | — | 3.50 |
| (5-1-1) | <10 | <10 | — | 0.07 |
| (5-2-0) | <10 | <10 | — | 2.20 |
| (5-2-1) | <10 | <10 | — | 0.05 |
| (6-0) | <10 | <10 | — | 2.81 |
| (6-1) | <10 | <10 | — | 0.05 |

*Using the methods described in the test methods section, the detection limits for NaAMPS, Acrylic Acid, acrylamide, and acrolein are 10 ppm, 10 ppm, 45 ppb, and 20 ppb, respectively. When the level of analyte measured is less than the detection limits, the value is reported as being less than the detection limit.

### Example 7

### Post Treatment of NaAMPS/Acrylic Acid Co-Polymer Hydro el with Different Compounds for Reduction of Byproducts and Residual Monomers

A. General Description of Gel Preparation

Approximately 22.4 parts of 50 wt % Na-AMPS solution, approx. 16.6 parts of acrylic acid and approx. 10.4 parts of deionized water are mixed together. To this solution approximately 5.5 parts 50 wt % NaOH is added dropwise with constant stirring, while maintaining the temperature below 30° C. with an ice bath. After addition of the NaOH approx. 44.8 parts of glycerol are added together with approx. 0.1 parts crosslinker (i.e IRR 210) and approx. 0.2 parts of photoinitiator (e.g Darocure 1173). The procedure is carried out in brown glassware which is covered with a brown watch glass to protect the reaction mixture from light. After stirring for about 15 to 30 minutes the reaction mixture is poured on a teflon coated plate to give a 1 mm thick layer. The reaction mixture is than irradiated with a 2000W Hönle UV lamp at 100 mW/cm2. Typical irradiation times range between 60s to 180s. The gels are then covered with regular photocopy paper and peeled of the plate. The other side of the gel is covered with a release liner (e.g. siliconized paper)

The samples treated with aminoguanidine were prepared with the 5-fold amount of photoinitiator.

B. Solutions for Post Treatment

Aqueous solutions of the post treatment agents are prepared by dissolving them in deionized water. Post treatment agents include but are not limited to, sodium bisulfite, aminoguanidine, Rongalit C, and ascorbinic acid.

C. Post-Treatments of Gels (Laboratory Samples)

Before the release liner is applied, the gels are post treated by spraying the above mentioned aqueous solutions uniformly to the surface with a DESAGA SG1 apparatus. After complete absorption of the solutions into the gels the release paper is applied and the samples are sealed in plastic bags. The samples are stored for at least 1 day before they are analyzed for residual monomers and byproducts.

D. Experimental Results

Series A:

| | Acrylic | AMPS | Acrolein |
|---|---|---|---|
| Hydrogel treated with | Acid (ppm) | (ppm) | (ppm) |
| — | 490 (8 days) | 560 (8 days) | NA |
| 1000 ppm ascorbinic acid | 379 (8 days) | NA | NA |
| 1000 ppm NaHSO₃ | 045 (8 days) | NA | NA |
| 750 ppm Rongalit C | 026 (8 days) | 164 (8 days) | NA |
| — | NA | NA | 2.21 |
| 10000 ppm Aminoguanidine | NA | NA | 0.07 |
| — | 370 | 577 | NA |
| 2000 ppm NaHSO₃ | 63 | 98 | NA |
| 5000 ppm NaHSO₃ | 57 | <10 | NA |

Series B:

| | AS | AMPS | Acrolein |
|---|---|---|---|
| Hydrogel treated with | (ppm) | (ppm) | (ppm) |
| 0 ppm NaHSO₃ | 15 | 37 | 0.84 |
| 500 ppm NaHSO₃ | 16 | 23 | 0.05 |
| 1000 ppm NaHSO₃ | 19 | 50 | 0.03 |
| 2500 ppm NaHSO₃ | 19 | 35 | <0.02 |
| 5000 ppm NaHSO₃ | 16 | <10 | <0.02 |

1. A process for making a hydrogel comprising from about 10 to 90 wt % water, from about 10 to 60 wt % of cross-linked hydrophilic polymer made from at least one starting monomer type, and from about 10 to 80 wt % of at least one polyol, said process comprising the steps of:
1) polymerizing said starting monomer(s) from within a reaction medium comprising from about 10 to 90 wt % of water, from about 10 to 60 wt % of said starting monomer(s) and from about 10 to 80 wt % of said polyol(s), to thereby form a hydrogel;
and thereafter
2) chemically treating said hydrogel with a compound which reacts with residual starting monomer(s), impurity(s) and/or any by-products produced by said polymerization reaction, to thereby reduce the concentration of said residual starting monomer(s), impurity(s) and/or by-products within said hydrogel.

2. A process according to claim 1 wherein the residual starting monomer(s) concentration in the hydrogel product of step 1), is reduced to below about 10000 ppm.

3. A process according to claim 2 wherein the residual monomer(s) concentration in the hydrogel product of step 1), is reduced to below about 10 ppm.

4. A process according to claim 1 wherein the polymerization of said starting monomer(s) is conducted at a pH from about 3.5 to 7.

5. A process according to claim 1 wherein said formed hydrogel comprises from about 20 to 70 wt % of water.

6. A process according to claim 1 wherein said chemical treatment in step 2) comprises adding to the hydrogel product of step 1) a nucleophile which reacts with said residual starting monomer(s), impurity(s) and/or by-products by an addition reaction.

7. A process according to claim 1 wherein said by-product(s) produced by said polymerization reaction, comprise α,β-unsaturated carbonyl(s) produced from said polyol(s).

8. A process according to claim 7 wherein said polyol(s) comprise glycerol.

9. A process according to claim 1 wherein said by-product(s) produced by said polymerization reaction, comprise acrolein.

10. A process according to claim 6 wherein said nucleophile is selected from the group consisting of ammonia, amines, polyamines, hydroxylamine, hydrazine, thiols, sulfites metabisulfites and bisulfites.

11. A process according to claim 10 wherein said nucleophile comprises bisulfite.

12. A process according to claim 11 wherein said bisulfite is present in amounts of less than about 30000 ppm, with respect to the hydrogel product of step 1).

13. A process according to claim 12 wherein the bisulfite is present in amounts of less than about 3000 ppm, with respect to the hydrogel product of step 1).

14. A process according to claim 1 wherein the polymerization of said starting monomer(s) is conducted at least partly by means of subjecting said starting monomer(s), said polyol(s) and said water to UV irradiation.

15. A process according to claim 14 wherein said reaction medium of step 1), comprises a photoinitiator.

16. A process according to claim 15 wherein said photoinitiator is selected from the group consisting of Darocur 1173, Irgacure 2959, Irgacure 500, and Irgacure 184.

17. A process according to claim 16 wherein said photoinitiator is used in said reaction medium at a concentration of less than about 5 wt %.

18. A process according to claim 17 wherein said photoinitiator is used in said reaction medium at a concentration of less than about 0.4 wt %.

19. A process according to claim 14 wherein the integrated UV intensity at wavelengths less than about 280 nm is less than about 10% of the total integrated UV intensity with wavelengths less than about 400 nm.

20. A process according to claim 19 wherein said polymerization is carried out by subjecting said starting monomer(s), said polyol(s) and said water to a total amount of UVA energy ranging from about 0.1 to 30 J/cm².

21. A process according to claim 1 wherein said starting monomer(s) comprise acrylic acid.

22. A process according to claim 1 wherein said hydrogel is adhesive.

23. A hydrogel comprising from about 10 to 90 wt % water, from about 10 to 60 wt % of cross-linked hydrophilic polymer made from starting monomer(s), and from about 10 to 80 wt % of a at least one polyol, said hydrogel being prepared by polymerizing said starting monomer(s) in the presence of said water and polyol(s), wherein said hydrogel comprises less than about 100 ppb of α,β-unsaturated carbonyl by-product(s) derived from said polyol(s) during polymerization.

24. A hydrogel according to claim 23 wherein said hydrogel comprises less than about 20 ppb of α,β-unsaturated carbonyl by-product(s) derived from said polyol(s) during polymerization.

25. A hydrogel according to claim 23 wherein said polyol(s) comprise glycerol.

26. A hydrogel according to claim 23 wherein said α,β-unsaturated carbonyl by-product comprises acrolein.

27. A hydrogel according to claim 23 which comprises less than about 200 ppm of residual starting monomer(s).

28. A hydrogel according to claim 27 which comprises less than about 10 ppm of residual starting monomer(s).

29. A hydrogel according to claim 23 wherein said starting monomer(s) comprise acrylic acid.

30. A hydrogel according to claim 22 wherein said hydrogel is adhesive.

31. A hydrogel comprising from about 10 to 90 wt % of water, from about 10 to 60 wt % of cross-linked hydrophilic polymer made from starting monomer(s), and from about 10 to 80 wt % of polyol(s), said hydrogel being prepared by polymerizing said starting monomer(s) in the presence of said water and said polyol(s) and thereafter, treating the formed product with a nucleophilic compound which reacts with α,β-unsaturated carbonyl by-product(s) derived from said polyol(s) during polymerization, wherein said hydrogel comprises more than about 20 ppb of nucleophilic addition product(s) of said α,β-unsaturated carbonyl by-product(s) with said nucloephilic compound.

32. A hydrogel according to claim 31 wherein said hydrogel comprises more than about 1000 ppb of nucleophilic addition product(s) of said α,β-unsaturated carbonyl by-product(s) with said nucloephilic compound.

33. A hydrogel according to claim 31 wherein said polyol(s) comprise glycerol

34. A hydrogel according to claim 31 wherein said nucleophilic addition product(s) comprise sodium 3-propanal sulfonate, 1-hydroxy-2-propene-1-sulfonate or 1-hydroxy-1.3-propane disulfonate.

35. A hydrogel according to claim 31 wherein said starting monomer(s) comprise acrylic acid.

36. A hydrogel according to claim 31 wherein said hydrogel is adhesive.
